(19) United States
(12) Patent Application Publication
(10) Pub. No.: US 2011/0001873 A1
(43) Pub. Date: Jan. 6, 2011

(54) FRAME RATE CONVERTER FOR INPUT FRAMES WITH VIDEO AND FILM CONTENT

(76) Inventors: Daniel Doswald, Munich (DE); Michael Joseph Erwin, Columbus, NJ (US); Samir Narayan Hulyalkar, Newtown, PA (US)

Correspondence Address: MCANDREWS HELD & MALLOY, LTD, 500 WEST MADISON STREET, SUITE 3400, CHICAGO, IL, 60661, US

(21) Appl. No.: 12/727,796

(22) Filed: Mar. 19, 2010

Related U.S. Application Data
(63) Continuation of application No. 12/535,408, filed on Aug. 4, 2009, now abandoned.
(60) Provisional application No. 61/136,022, filed on Aug. 6, 2008.

(51) Int. Cl. H04N 7/01

(52) U.S. Cl. 348/448; 348/459; 348/E07.003

(57) ABSTRACT

A frame rate converter device and method for interpolation during frame rate conversion are disclosed. The method includes, receiving input frames containing film content and video content. The film content exhibits a 3:2 pull-down cadence while video content that does not exhibit such cadence. Consecutive frames Cₙ and Cₙ₊₁ are interpolated to form Fₙ using the frame rate converter. The frame rate converter further selects as an output frame, either current or previous ones of interpolated frames or input frames. The selection is made so as to reduce both film judder and video judder. The invention is suitable for use on video input frames at 60 frames per second (fps) derived from a 24 fps cinema using 3:2 pull-down, and also blended with 60 Hz overlay video such as subtitle text. The invention can be used to obtain a good overall reduction in both overlay video judder and film judder.

### RELATED APPLICATIONS

This application is a continuation of co-pending U.S. application Ser. No. 12/535,408, filed Aug. 4, 2009, entitled “FRAME RATE CONVERTER FOR INPUT FRAMES WITH VIDEO AND FILM CONTENT”, having as inventors Daniel Doswald et al. and is incorporated herein by reference, which claims benefits from U.S. Provisional Patent Application No. 61/136,022, filed Aug. 6, 2008, the contents of which are hereby incorporated herein by reference.

### FIELD OF THE INVENTION

The present invention relates generally to video processing, and more particularly to adaptive frame rate conversion.

### BACKGROUND OF THE INVENTION

Video is typically recorded or captured at a predetermined frame rate. For example, cinema films are typically recorded at a fixed rate of 24 frames per second (fps).

Captured video may be transmitted as a sequence of frames. Such video sequences are called progressive. On the other hand, the odd or even scan lines of a frame may be transmitted separately as individual fields. A field made up of odd scan lines is called an odd field while a field made up of the even lines of a frame is called an even field. Video that is transmitted as a sequence of fields is called interlaced.

In North America, video broadcast for television conforming to the NTSC standard is interlaced, and is transmitted at a rate of 60 fields per second. In Europe, video broadcast that conforms to PAL or SECAM standards is transmitted at 50 fields per second.

It is often desirable to playback video at a different frame rate than the rate at which it was recorded. For example cinema films are often converted to video cassette tapes or DVDs or transmitted for viewing at home on NTSC compliant television. Accordingly, cinema captured at 24 fps is transmitted as interlaced video at 60 fields per second. However, only 48 distinct fields per second can be formed from a 24 fps progressive cinema source.

To achieve the desired NTSC rate, telecine conversion (often referred to as 3:2 pull-down) is used to convert a 24 fps motion picture and transmit it at 60 fields per second. In telecine conversion, in stead of forming two fields for each frame, each second frame spans 3 fields, while each other second frame spans two fields. That is, five fields are transmitted for every two frames of cinema resulting in 24×( 5/2)=60 fields per second. Telecine conversion is detailed for example, in Charles Poynton, Digital Video and HDTV Algorithms and Interfaces, (San Francisco: Morgan Kaufmann Publishers, 2003), the contents of which are hereby incorporated by reference.

At a receiver having a progressive display, video received at 60 fields per second may first be deinterlaced to form 60 frames per second of progressive video. Typically, each received field is converted to a frame. This may be achieved by identifying and combining even and odd fields belonging to the same frame, by line doubling, by interpolating missing lines of a field and the like.

The cinema capture rate of 24 Hz may be too low to describe certain types of motion. The result is typically motion artifact called film judder. The effect of film judder is to make moving objects appear to jump from one position to another, rather than appearing to move smoothly.

Although telecine allows cinema content to be transmitted at 60 fields per second, no new temporal information is introduced to the original content. As such, telecine does not mitigate artifacts that result from low temporal sampling rates.

In fact, telecine conversion typically exacerbates film judder resulting from 3:2 pull-down pattern and this judder is sometimes referred to as telecine judder. Telecine judder is due to the fact that the de-interlaced frames are displayed for uneven durations, alternately lasting for either 2 frame periods, or 3 frame periods as will be the case in frames formed from telecine fields. This in turn may cause slow steady movements to appear jerky.

Recently, higher display rates have been used to improve video quality. For example, in an effort to reduce perceptible flicker associated with conventional PAL televisions, high frame rate 100 fields per second televisions have become available. Similarly, it may be desirable to convert and display at 120 fps, video that was received at 60 fields per second, to improve quality.

In the future, video may be captured at much higher frame rates to provide higher quality home video. Existing video, however, is not readily available at these higher frame rates and thus frame rate conversion will be necessary.

As such, video received at 60 fields per second can be deinterlaced to form 60 fps progressive output and further converted to provide a 120 fps progressive video sequence to improve output quality. The deinterlaced 60 fps video may be derived from an original 24 fps film by 3:2 pull-down.

To further convert this 60 fps video sequence to an even higher frame rate (e.g., 120 fps), a reverse telecine process can be used to first recover the original frames of the 24 fps source cinema. The original frames can then be frame rate converted to a desired higher frame rate using known interpolation techniques. One such method is disclosed for example, in a US patent application with application Ser. No. 11/616,192 assigned to the present assignee.

Unfortunately, performing reverse telecine to recover original cinema frames, prior to interpolation during frame rate conversion is not always ideal. For example, it is not uncommon for a 60 fields per second video with a 3:2 pull-down cadence, to be combined or blended with another 60 fields per second field sequence in order to introduce overlay subtitles, animations, tickers, graphics and the like. The resulting 60 fields per second video, thus contains subtitle texts and/or other overlays that were not in the original 24 fps cinema. The film content within the fields exhibits a 3:2 pull-down pattern, but the overlay content (e.g., subtitle text or graphics) does not. Accordingly, performing a reverse telecine on such a field sequence would distort overlay content.

Accordingly, there is a need for improved frame rate conversion of a frame sequence which may include film-derived content and video content that are captured a different rates, so as to improve the overall quality of the resulting higher frame rate video output.

### SUMMARY OF THE INVENTION

A frame rate conversion method includes accepting and buffering input video frames received at a given frame rate and providing output frames at a different frame rate. The input video frames may contain a mixture of contents each with different cadences such as cinema derived video with subtitles. The first content may have a first cadence and a second content may have a different second cadence. The frame rate conversion method involves forming an interpolated frame for each of the input video frames. Output frames are provided by selecting and outputting either an interpolated frame or one of the buffered input video frames, depending on the first cadence. The selection is made so to reduce judder in both the first and second contents in the output frames. The method may output more interpolated frames than conventional methods. The method is suited for use with video inputs that result from blending or combining video sequences that have differing cadences such as cinema-derived video having a 3:2 pull-down cadence blended with overlay video sequence such as subtitle text, having no 3:2 pull-down cadence. By interpolating and outputting more interpolated frames, the method may reduce judder in the overlay video without adversely impacting judder in the cinema-derived content of the output frames.

In accordance with one aspect of the present invention, there is provided a method of providing frame rate converted video. The method includes buffering sequential input video frames received at a first frame rate in a buffer. The input video frames may contain a blended content formed by combining a first content from a first video sequence having a first cadence; and a second content from a second video sequence having a second cadence. The method also includes forming interpolated frames by interpolating at least two of the input video frames in the buffer to form a corresponding interpolated frame for each of the input video frames. The method also includes providing output frames at a second frame rate, by selectively outputting one of the interpolated frames, or the frames in the buffer, as an output frame, depending on the first cadence so as to reduce video judder in the second content in the output frames.

In accordance with another embodiment of the present invention, there is provided, a method of converting input video frames received at a first rate into output frames provided at a second rate. The input video frames may contain a blend of a first and a second video content having a first and a second cadence respectively. The method includes: detecting the first cadence, detecting the second cadence; and providing the output frames by selectively interpolating the input video frames based on the first and second cadence so as to reduce judder in the first and second content in the output frames.

In accordance with another embodiment of the present invention, there is provided, a frame rate converter circuit. The circuit includes an interpolator for forming interpolated video frames from at least two input video frames received sequentially at a first rate. The input video frames may contain a first and second content formed from two video sequences having a first and a second cadence respectively. The circuit also includes: a cadence detector for detecting at least one of the first and second cadence to provide a cadence indicator; a controller for providing a selection parameter based on the cadence indicator, determined so as to reduce judder in the first and second contents in the output frames; and an output interface for providing output frames at a second rate by selectively outputting one of the input video frames and the interpolated video frames, in accordance with the selection parameter.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a simplified schematic block diagram of video device including a frame rate converter, exemplary of the present invention;

FIG. 2 is a logical diagram of a sequence of original film frames at 24 fps, converted to 3:2 pull-down field sequence having a rate of 60 Hz;

FIG. 3 is a logical diagram of a blending device accepting the 3:2 pull-down input field sequence to the deinterlacer of FIG. 2, and another field sequence of video content, to output a blended field sequence containing both film and video content;

FIG. 4 is a plot of video judder exhibited by the output of a conventional frame rate converter accepting the resulting frame sequence of FIG. 3 as input, and outputting a frame sequence at double the incoming frame rate; and

FIGS. 5-6 are plots of video judder exhibited by the output of a frame rate converter, exemplary of an embodiment of the present invention, accepting the resulting frame sequence of FIG. 3 as input, and outputting a frame sequence at double the incoming frame rate.

### DETAILED DESCRIPTION

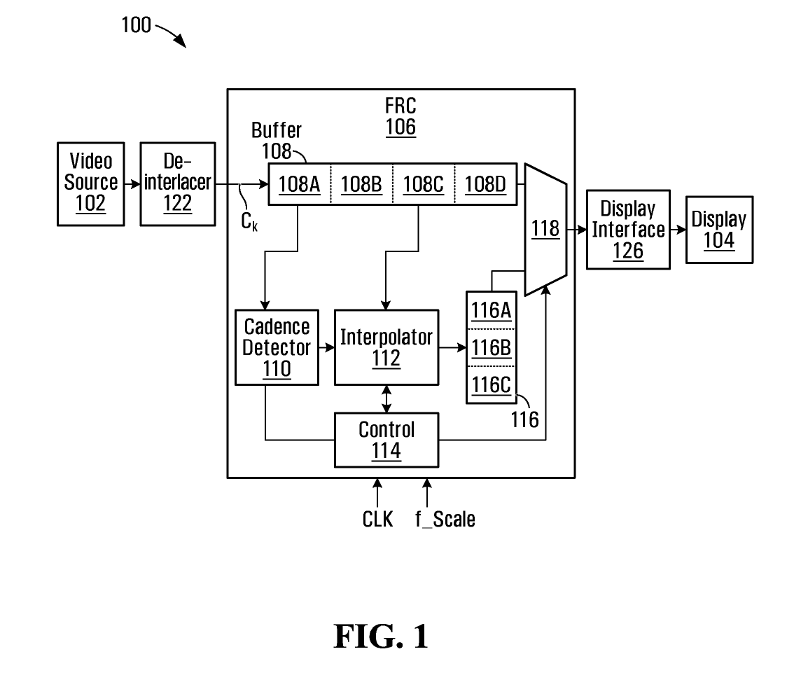

FIG. 1 illustrates a video device 100 including a video source 102, a display 104 and a frame rate converter (FRC) 106, exemplary of an embodiment of the present invention. Video source 102 receives a video input signal, and provides a decoded sequence of video frames to FRC 106.

Video source 102 may receive a video signal in the form of a compressed stream of digital video such as MPEG 2, MPEG 4, H264 or the like and provide a decompressed video frame or field sequence. Video source 102 may include a decoder for forming fields or frames of decoded video. Video source 102 may similarly output a decoded audio stream for further processing. Video source 102 may also receive video signals in other formats such as a DVI, HDMI, or DisplayPort cable, or via an analog video interface such as VGA.

Video device 100 may take the form of a set top box, satellite receiver, terrestrial broadcast receiver, media player (e.g. DVD player or Blu-ray player), media receiver, a personal computer or the like, interconnected to a display device. Display device 104 may be a flat panel television, a computer monitor, a portable television, or the like. Device 100 may be formed in custom hardware, or a combination of custom hardware and general purpose computing hardware under software control.

The video input signal provided by video source 102 may be in the form of a sequence of fields. FRC 106 may thus include a frame formation circuit such as deinterlacer 122 to produce deinterlaced frames from the received fields.

FRC 106 also includes an input buffer 108, a cadence detector 110, an interpolator 112, a controller 114 and a buffer 116 for storing interpolated frames. FRC 106 may also be in communication with a display interface 126 which provides interconnection to display 104. Input buffer 108 stores several input frames Cₖ received from video source 102, by way of deinterlacer 122 accepting frames from video source 102. In the depicted embodiment, buffer 108 may store at least four frames in frame buffer locations 108A, 108B, 108C, and 108D.

Cadence detector 110 is a circuit block for detecting known patterns such as a 3:2 pull-down pattern in the received frame sequence. As will be detailed later, received video frames may contain sequences with several types of patterns, which should be detected by cadence detector 110 to control the operation of interpolator 112.

Interpolator 112 is used to form interpolated frames, using received frames stored buffer 108 as inputs. Interpolated frames are stored in buffer 116. In the depicted embodiment, at least three interpolated frames can be stored with in buffer 116 in locations 116A, 116B and 116C.

Controller 114 may be a processor such as a general purpose central processing unit (CPU). Controller 114 is used to control the operation of FRC 106. As depicted, FRC 106 may include an output interface 118 controllable by controller 114, to selectively output a frame from either buffer 108 or buffer 116. For example, output interface 118 may be operated as a multiplexer outputting a frame from buffers 116, 114 in response to an input from controller 114.

Buffer 108 is a first in first out (FIFO) buffer that stores several frames of video. In the depicted embodiment, buffer 108 stores at least four sequential received frames Cᵢ, C₊₁, C₊₂, C₊₃ in locations 108A, 108B, 108C, and 108D respectively.

Interpolator 112 extracts at least two of the received frames from buffer 108 in order to produce each interpolated frame, which is subsequently stored in buffer 116. Interpolator 112 may perform motion compensated interpolation. Alternately interpolator 112 may make use of linear interpolation, predictive interpolation, adaptive motion compensated interpolation, or the like. As noted above, at least three interpolated frames Fⱼ, Fⱼ₊₁, Fⱼ₊₂ may be stored in buffer 116. Output frames fₖ may be formed by selecting either an interpolated frame Fⱼ from buffer 116 or a received frame Cᵢ from buffer 108 and provided output interface 118 for presentation on interconnected display 104.

Output frames fₖ from FRC 106 may be stored in an optional frame buffer which may be sampled by a display interface (not shown) for presentation on display 104. The display interface may take the form of a conventional random access memory digital to analog converter (RAMDAC), a single ended or differential transmitter conforming to HDMI or DVI standard, or any other suitable interface that converts data in a frame buffer for display in analog or digital form on display 104.

Cadence detector 110 analyses adjacent frames in buffer 108 to determine, if the input frame sequence includes frames that repeat in a known pattern. For example, cadence detector 110 determines whether or not generated video frames stem from a source exhibiting 3:2 or 2:2 or similar pull-down pattern. An indicator of the cadence is provided to controller 114.

Functional blocks of device 100 including video source 102 and frame rate converter 106 may be formed using conventional VLSI design techniques and tools known to those of ordinary skill.

A frequency scaling factor (f_scale) and clock signal (CLK) for deriving the resulting frame rate, may be provided to FRC 106. Such parameters may be provided to interpolator 112 via controller 114. Interpolator 112 may be provided with cadence information about frames in the currently received frame sequence from cadence detector 110.

For notational convenience, frames output by video source 102 and received in buffer 108 are referred to as frames C₀, C₁, C₂, . . . while interpolated frames formed by interpolator 112 and stored in buffer 116 are denoted as frames F₀, F₁, F₂, . . . .

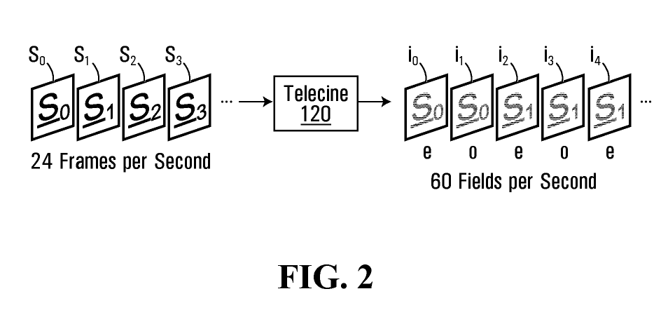

Frames C₀, C₁, C₂ . . . may themselves be formed from a cinema film source. FIG. 2, depicts a logical diagram of a 24 fps cinema film source S₀, S₁, S₂ . . . having film contents S₀, S₁,S₂ . . . , , that is received in a telecine converter 120 which outputs interlaced fields i₀, i₁, i₂, i₃, i₄ . . . at field rate of 60 Hz (i.e., 60 fields per second). The field sequence i₀, i₁, i₂, i₃, i₄ . . . exhibits a 3:2 pull-down cadence, for portions that are derived from a 24 fps cinema input. For example, the contents of i₀, i₁, i₂ correspond to S₀ wile the contents of i₃, i₄ correspond to S₁ exhibiting a 3:2 pull-down pattern. The field sequence i₀, i₁, i₂ . . . can be deinterlaced and frame rate converted, using reverse telecine to recover original film frames. However, the sequence i₀, i₁, i₂ . . . may sometimes be combined or blended with another overlay sequence prior to reception—in which case reverse telecine may not be a suitable option.

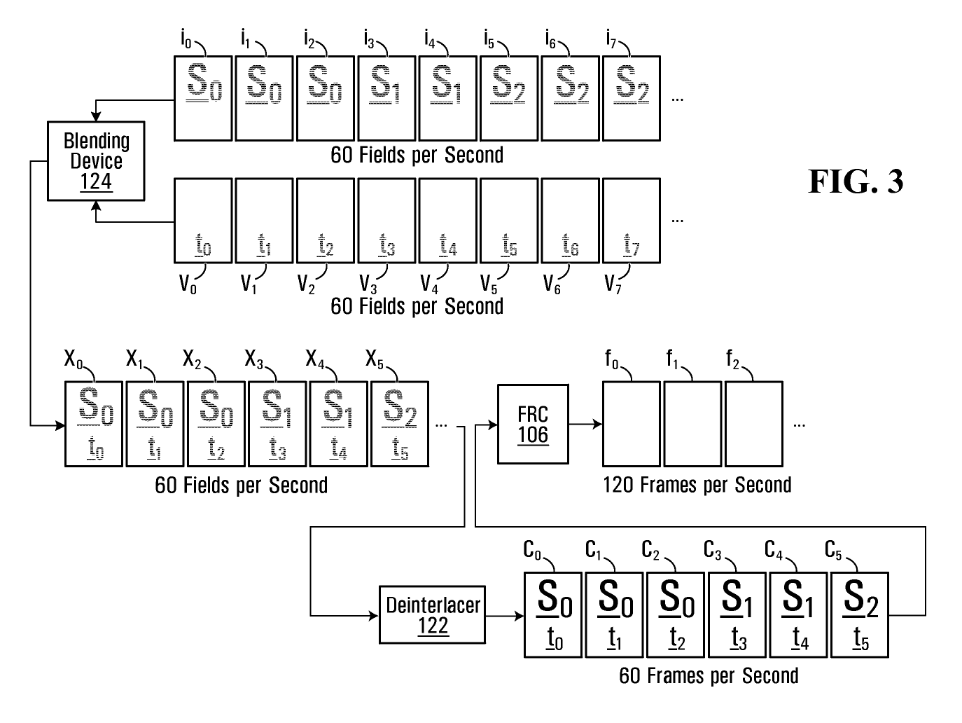

FIG. 3 is a logical diagram depicting a blending operation in which the output sequence of fields i₀, i₁, i₂, i₃, i₄ . . . of FIG. 2 and a new sequence of overlay video fields V₀, V₁, V₂, V₃, V₄ . . . with overlay contents t₀, t₁, t₂, t₃, t₄ . . . are received in a blending device 124 to output blended fields X₀, X₁, X₂ . . . .

The blending operation is also known as compositing or alpha-blending. Such blending operations are common and may arise for example when subtitle text, ticker symbols, PiP video, animation graphics overlay or the like are added onto existing motion video. Blending may take place prior to reception of video fields by video device 100. Overlay text, subtitles, ticker symbols or the like may be overlaid on a 3:2 pull-down field sequence prior to transmission of the video signal. For example, a DVD player may overlay subtitle text onto decoded fields or frames prior to forming output frames, which would be buffered in FRC 106. Blending of several layers may also be performed by a Blu-ray player which may provide presentation graphics and/or interactive graphics streams as auxiliary data to be overlaid onto the main video. The main video and auxiliary streams may have different cadences. A display device may also present two channels simultaneously by forming a first channel as a picture-in-picture window of the second channel. If the cadence of the second channel which may be film derived with 3:2 pull-down pattern differs from the first which may be 60 fps, then FRC 106 may be used to reduce video judder in the first.

A deinterlacer 122, which may form part of FRC 106, receives the 60 Hz field sequence X₀, X₁, X₂ . . . transmitted by device 124 and outputs a 60 fps deinterlaced frame sequence C₀, C₁, C₂, C₃, C₄, C₅ . . . . As depicted, the deinterlaced frame sequence C₀, C₁, C₂, C₃, C₄, C₅ . . . thus contains both 3:2 pull-down film-derived content S₀, S₀, S₀, S₁, S₁, S₂, . . . and the overlay video content t₀, t₁, t₂, t₃, t₄, t₅ . . . .

In some embodiments, the output of device 124 may be compressed by an encoder such as an MPEG encoder prior to being transmitted. In such scenarios, the receiver (e.g. video source 102) typically includes a decoder that receives the compressed output of device 124, and decodes the received data to output fields X₀, X₁, X₂ . . . which may further be deinterlaced form frames C₀, C₁, C₂ . . . .

Regardless of the exact manner of their formation, frames C₀, C₁, C₂, C₃ . . . are buffered by FRC 106 in buffer 108. Notably, within the sequence of frames C₀, C₁, C₂, C₃, C₄, C₅ . . . as depicted in FIG. 3, the film-derived content (i.e., S₀, S₀, S₀, S₁, S₁, S₂ . . . ) may exhibit a 3:2 pull-down pattern, while the overlay video content (i.e., t₀, t₁, t₂, t₃, t₄, t₅ . . . ) need not exhibit the 3:2 pull-down pattern. As noted above, output frames C₀, C₁, C₂ . . . from video source 102 are buffered in buffer 108 of FRC 106.

Frame rate conversion of a 60 fps input to produce a 120 fps output involves interpolating a frame between each of the input frames in order to output double the number of input frames for a given time interval. Specifically, given an input sequence C₀, C₁, C₂, C₃, C₄, . . . , Cₖ . . . a frame rate converter may output a frame sequence f₀, f₁, f₂, f₃, f₄, . . . f₂ₖ, f₂ₖ₊₁ . . . corresponding to C₀, F₀, C₁, F₁, C₂, F₂, C₃, F₃, . . . Cₖ, Fₖ, . . . where each Fₖ is obtained by interpolating input frames Cₖ and Cₖ₊₁. This works well enough for inputs without a 3:2 pull-down cadence.

For convenience, each interpolated frame as Fₖ and the relationship between frame Fₖ, Cₖ, Cₖ₊₁ as Fₖ=|{Cₖ, Cₖ₊₁} to indicate that frame Fₖ is the result of interpolating frames Cₖ and Cₖ₊₁. We denote the content of a frame corresponding to an original film source frame Sⱼ by underlining it as Sⱼ while the content of source frame Sⱼ₊₁ is similarly denoted by Sⱼ₊₁. Assuming that the film-derived contents of Cₖ, Cₖ₊₁ are Sⱼ and Sⱼ₊₁ respectively, the content of Fₖ=|{Cₖ, Cₖ₊₁} is denoted by S_{j+0.5}. In other words, S_{j+0.5} may be used to denote frame content obtained by interpolating original film frames Sⱼ and Sⱼ₊₁. Similarly S_{j+1.5} denotes frame content obtained by interpolating frame film contents Sⱼ₊₁ and Sⱼ₊₂. In general, interpolating frames with contents Sₘ and Sₘ₊₁ would result in a frame whose content is denoted by S_{m+0.5}.

In the presence of a 3:2 pull-down cadence, the film-derived content of the input sequence Cₖ Cₖ₊₁Cₖ₊₂Cₖ₊₃Cₖ₊₄ corresponds to Sⱼ Sⱼ Sⱼ Sⱼ₊₁ Sⱼ₊₁. As noted above, Fₖ=|{Cₖ, Cₖ₊₁}, that is Fₖ is formed by interpolating Cₖ and Cₖ₊₁. The film content of Fₖ thus depends on the film contents of Cₖ, Cₖ₊₁.

Conventional FRCs need not perform interpolations where the input film contents are known to be the same. If the film-derived content of both Cₖ and Cₖ₊₁ correspond to the same original film frame Sⱼ then there is no need to perform explicit interpolation of Fₖ=|{Cₖ, Cₖ₊₁}|{Sⱼ,Sⱼ}=Sⱼ. It should be noted that cadence information is obtained from the film content of frames C₀, C₁, C₂ . . . which is the dominant content when the overlay video content is subtitle text, a small PiP window, graphics overlay or the like. Cadence detector 110 may also provide a first and second cadence indicators corresponding to the main (e.g., potentially film-derived) content and also the overlay video content (e.g. PiP or subtitle) respectively.

Now, if the input frame sequence contains both film content (3:2 pull-down cinema content) and video content (e.g., a 60 Hz PiP video or subtitle text at 60 Hz) then the use of a conventional FRC would lead to video distortion as a result of taking the 3:2 pull-down of the film content into account.

TABLE I below depicts an exemplary input frame sequence Cₖ, Cₖ₊₁, Cₖ₊₂ . . . containing a blended content which includes both film content with a first (e.g. 3:2 pull-down) cadence and video content with a second cadence different from the first. The input frame sequence may be received at a frame rate of 60 Hz (i.e., at 60 fps).

TABLE I
Input frames

| | | | | | |
|---|---|---|---|---|---|
| Input frame index | Cₖ | Cₖ₊₁ | Cₖ₊₂ | Cₖ₊₃ | Cₖ₊₄ |
| Film Content | Sᵢ | Sᵢ | Sᵢ | Sᵢ₊₁ | Sᵢ₊₁ |
| Video content (overlay) | tₖ | tₖ₊₁ | tₖ₊₂ | tₖ₊₃ | tₖ₊₄ |

Given an input frame sequence as shown in TABLE I, the corresponding output provided by a conventional FRC is depicted in TABLE II. The table depicts an output frame sequence fₙ, fₙ₊₁, . . . from a conventional FRC. The 3:2 pull-down pattern of the input sequence is evident in the Film Content row. Recall that the visual content of frame Cₖ is dominated by its film content Sⱼ (as tₖ may be PiP or subtitle text).

Accordingly, as shown in TABLE II, a conventional FRC would not perform explicit interpolation of Fₖ for example to output fₙ₊₁, but instead simply outputs a frame having a film content Sⱼ. This may be done by enabling/disabling its interpolation engine based on the detected cadence of the input frame sequence. The same holds true for other frames fₙ₊₅ and fₙ₊₇ output by a conventional FRC. However, to form fₙ₊₃, fₙ₊₄, (TABLE II) a conventional FRC would have to interpolate Cₖ (or Cₖ₊₁ or Cₖ₊₂) and Cₖ₊₃ as the film contents in the two frames are different (i.e., Sᵢ, and Sᵢ₊₁ respectively from TABLE I). Output frame fₙ₊₁ (or equivalently frame Fₖ₊₂) is thus an interpolated frame containing a newly formed interpolated film content S_{i+0.5}. In other words, output frames fₙ₊₃, fₙ₊₄ are not be simply selected from input frame such as Cₖ, Cₖ₊₁, . . . but must be constructed by interpolation.

TABLE II

| | | | | | |
|---|---|---|---|---|---|
| Input frames | Cₖ₊₁ | Cₖ₊₂ | Cₖ₊₃ | Cₖ₊₄ | Cₖ₊₅ |

Output frames (Conventional FRC)

| | | | | | | | | | | |
|---|---|---|---|---|---|---|---|---|---|---|
| Output index | fₙ | fₙ₊₁ | fₙ₊₂ | fₙ₊₃ | fₙ₊₄ | fₙ₊₅ | fₙ₊₆ | fₙ₊₇ | fₙ₊₈ | fₙ₊₉ |
| Frame index | Cₖ | Cₖ₊₁ | Cₖ₊₁ | Fₖ₊₁ | Fₖ₊₁ | Cₖ₊₃ | Cₖ₊₃ | Cₖ₊₃ | Fₖ₊₃ | Fₖ₊₃ |
| Film content | Sᵢ | Sᵢ | Sᵢ | S_{i+0.5} | S_{i+0.5} | Sᵢ₊₁ | Sᵢ₊₁ | Sᵢ₊₁ | S_{i+1.5} | S_{i+1.5} |
| Video content | tₖ | tₖ₊₁ | tₖ₊₁ | t_{k+1.5} | t_{k+1.5} | tₖ₊₃ | tₖ₊₃ | tₖ₊₃ | t_{k+3.5} | t_{k+3.5} |
| Ideal video | tₖ | t_{k+0.5} | tₖ₊₁ | t_{k+1.5} | tₖ₊₂ | t_{k+2.5} | t_{k+2.5} | tₖ₊₃ | t_{k+3.5} | tₖ₊₄ |

Conventional frame rate conversion by interpolation as described above using a conventional FRC has drawbacks. For example, upon cadence detection, interpolated frame (e.g. Fₖ₊₁) is outputted twice, and then followed by outputting an input frame (e.g., Cₖ₊₃) three times. In other words, interpolation is performed only if sequential input frames to do not contain identical film content (e.g., for Cₖ₊₂, Cₖ₊₃ in TABLE I).

However, this is disadvantageous for input frames C₀, C₁, C₂, . . . that contain identical film-derived content (i.e., S₀, S₀, S₀), but also contain overlay video contents that differ (i.e., t₀, t₁, t₂,). As depicted in FIG. 3, the content of each frame Cᵢ, includes both film content Sⱼ and video content tᵢ.

Conventional frame rate conversion, that takes the cadence of the film content into account but fails to consider the video content, may thus introduce distortions into the output video content during frame rate conversion. In particular a conventional FRC outputs video contents tₖ, tₖ₊₁, tₖ₊₁, t_{k+0.5}, t_{k+0.5}, tₖ₊₃, tₖ₊₃, tₖ₊₃, t_{k+3.5}, t_{k+3.5} (TABLE II) which exhibits video judder. A judder free overlay video content sequence would be as depicted in the last row of TABLE II.

In contrast, exemplary FRC 106 performs frame rate conversion differently. FRC 106 receives input frames in buffer 108 and cadence detector 110 may analyze the received frames to provide a cadence indicator to interpolator 112 and controller 114. As noted above, a scaling frequency input as well as a clock signal may also be received by FRC 106. An exemplary case of frame doubling with an input frame rate of 60 fps and an output rate is 120 fps is described.

In operation, interpolator 112 may constantly interpolate and store one frame for each received frame input. As noted above, interpolator 112 may perform motion compensated interpolation, or any other type of temporal or spatiotemporal video interpolation. In the absence of a 3:2 pull-down cadence of the film content, detected by cadence detector or indicated by a cadence indicator, neither the overlay video judder nor film judder are likely to be pronounced and output interface 118, may alternately select and output one input frame, followed by one interpolated frame to achieve the desired output frame rate. However, upon cadence indication, exemplary FRC 106 selectively outputs frames as indicated in TABLE III so as to reduce both film judder and video judder.

In contrast to a conventional FRC, the exemplary embodiment of FRC such as FRC 106, keeps its interpolation engine operating even when cadence detector 110 indicates a 3:2 pull-down pattern (based on the film content). Accordingly, more interpolated frames Fₖ are available to output in exemplary FRC 106.

Advantageously, interpolated frames introduce less distortions to the film content as interpolating the two frames (e.g., Cₖ, Cₖ₊₁ same film content Sᵢ would simply produce another frame fₙ₊₁ having the same film content Sᵢ. However, the video content of fₙ₊₁ would be an interpolated content t_{k+0.5} (TABLE III) which reduces judder. In contrast, the video content of fₙ₊₁ in TABLE II is tₖ₊₁ which increases video judder.

Interpolator 112 forms interpolated video frames from at least two input video frames sequentially buffered in buffer 108. Output interface 118 selectively outputs either one of the input frames Cₖ or an interpolated frame Fₖ, in accordance with a selection parameter dependent on the current value of a cadence indicator provided by cadence detector 110, indicative of the cadence of the input frames in buffer 108.

The selection parameter for outputting either an interpolated frame (e.g., Fₖ) from buffer 116 or a buffered input frame from buffer 108 (e.g., Cₖ), may be determined by controller 114, so as to reduce both film and video judder in the output frame sequence. Control 114 attempts to reduce film judder when cadence indicator received from detector 110 indicates the presence of a 3:2 pull-down pattern in the film content of buffered input frames.

Hence, the output of an exemplary FRC would have a video content sequence tₖ, t_{k+0.5}, tₖ₊₁, t_{k+1.5}, t_{k+1.5}, tₖ₊₂, t_{k+2.5}, tₖ₊₃, t_{k+3.5}, t_{k+3.5} (TABLE III) which exhibits less video judder. Notably, film judder in the output of FRC 106 would be no worse than film judder under conventional frame rate conversion, as Film Content rows of both TABLE II and TABLE III are identical. However, video judder in the overlay content, under exemplary embodiments of the present invention would be greatly improved.

TABLE III
Output frames (Exemplary FRC)

| | | | | | | | | | | |
|---|---|---|---|---|---|---|---|---|---|---|
| Input index | Cₖ₊₁ | | Cₖ₊₂ | | Cₖ₊₃ | | Cₖ₊₄ | | Cₖ₊₅ | |
| Output index | fₙ | fₙ₊₁ | fₙ₊₂ | fₙ₊₃ | fₙ₊₄ | fₙ₊₅ | fₙ₊₆ | fₙ₊₇ | fₙ₊₈ | fₙ₊₉ |
| Frame index | Cₖ | Fₖ | Cₖ₊₁ | Fₖ₊₁ | Fₖ₊₁ | Cₖ₊₂ | Fₖ₊₂ | Cₖ₊₃ | Fₖ₊₃ | Fₖ₊₃ |
| Film content | Sᵢ | Sᵢ | Sᵢ | S_{i+0.5} | S_{i+0.5} | Sᵢ₊₁ | Sᵢ₊₁ | Sᵢ₊₁ | S_{i+1.5} | S_{i+1.5} |
| Video (overlay) | tₖ | t_{k+0.5} | tₖ₊₁ | t_{k+1.5} | t_{k+1.5} | tₖ₊₂ | t_{k+2.5} | tₖ₊₃ | t_{k+3.5} | t_{k+3.5} |
| Ideal video | tₖ | t_{k+0.5} | tₖ₊₁ | t_{k+1.5} | tₖ₊₂ | t_{k+2.5} | tₖ₊₃ | t_{k+3.5} | tₖ₊₄ | t_{k+4.5} |
| (overlay) | | | | | | | | | | |

Ideally, video judder is minimized with respect to a 60 fps input sequence with video contents tₖ, tₖ₊₁, tₖ₊₂, tₖ₊₃, tₖ₊₄, if the content of the corresponding 120 fps output from an FRC is tₖ, t_{k+0.5}, tₖ₊₁, t_{k+1.5}, tₖ₊₂, t_{k+2.5}, tₖ₊₃, t_{k+3.5}, tₖ₊₄ . . . . To the extent that there are large sequences of video contents exhibiting this type regularity as shown in TABLE III (e.g., from fₙ to fₙ₊₃ and also from fₙ₊₄ to fₙ₊₈) video judder is reduced.

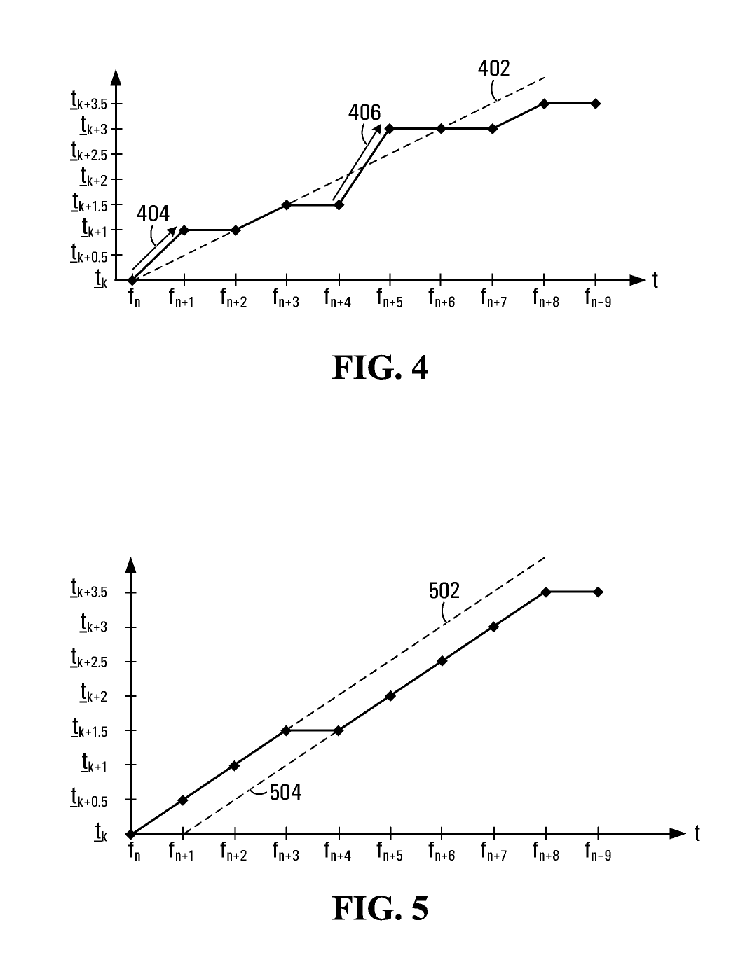

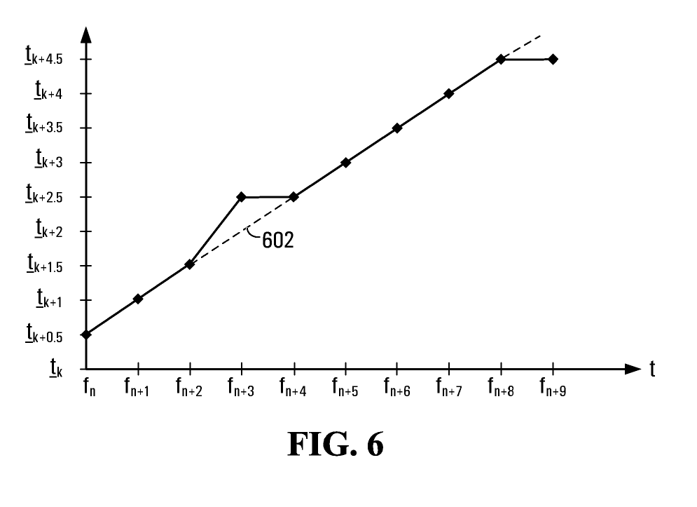

This is visually illustrated in FIG. 4 and FIG. 5 which depict plots of video judder for output frames from a conventional FRC and an exemplary FRC respectively. In FIGS. 4-5, the horizontal axis is a time axis. Each label on the horizontal axis (e.g., fₙ) denotes an instant at which frame fₙ is output by the FRC, while the corresponding actual video content output by the frame is depicted on the vertical axis. A judder free video output would be a straight line in which the actual video content (vertical axis) varies linearly with each output frame (horizontal axis).

Video judder may be understood to vary roughly proportionally to the deviation of each point from an ideal line for judder free video. The film content of output frames is not shown as the film content remains substantially the same for both cases (as can be seen in TABLES II and III).

A judder plot that more closely approximates a straight line corresponds to less perceptible video judder and hence better visual quality. FIG. 4 depicts a plot of video judder for output frames from a conventional FRC. Ideally all outputs points lie along a line 402. However, this is observed only for frames fₙ, fₙ₊₂, fₙ₊₃ and fₙ₊₆ which lie along line 402. Sharp displacements such as displacement 404 and displacement 406 correspond to perceptible video judder.

FIG. 5 depicts a plot of video judder for a frame sequence output by an FRC 106 exemplary of the present invention such as FRC 106 of FIG. 1. As can be seen, the video judder for the output of the exemplary FRC 106 is much smaller than the corresponding judder for the conventional FRC depicted in FIG. 4. In particular it is observed that video content output by FRC 106 all lie very close to an ideal straight line 502. In fact the video contents for frames fₙ, fₙ₊₁, fₙ₊₂, fₙ₊₃, fₙ₊₄, fₙ₊₅ lie along line 502. In addition, outputs for fₙ₊₅, fₙ₊₆, fₙ₊₇, fₙ₊₈, also lie along another straight line 504 parallel to and close to line 502. There are no sharp displacements in FIG. 5, comparable to displacements 404 and 406 in FIG. 4.

As would be appreciated by those of ordinary skill, perceptible video judder may be appreciably reduced in exemplary embodiments of the present invention, without affecting film judder.

TABLE IV
Output frames (Second Exemplary FRC)

| | | | | | | | | | | |
|---|---|---|---|---|---|---|---|---|---|---|
| Input index | Cₖ₊₁ | | Cₖ₊₂ | | Cₖ₊₃ | | Cₖ₊₄ | | Cₖ₊₅ | |
| Output index | fₙ | fₙ₊₁ | fₙ₊₂ | fₙ₊₃ | fₙ₊₄ | fₙ₊₅ | fₙ₊₆ | fₙ₊₇ | fₙ₊₈ | fₙ₊₉ |
| Frame index | Fₖ | Cₖ₊₁ | Fₖ₊₁ | Fₖ₊₂ | Fₖ₊₂ | Cₖ₊₃ | Fₖ₊₃ | Cₖ₊₄ | Fₖ₊₄ | Fₖ₊₄ |
| Film content | Sᵢ | Sᵢ | Sᵢ | S_{i+0.5} | S_{i+0.5} | Sᵢ₊₁ | Sᵢ₊₁ | Sᵢ₊₁ | S_{i+1.5} | S_{i+1.5} |
| Video (overlay) | t_{k+0.5} | tₖ₊₁ | t_{k+1.5} | t_{k+2.5} | t_{k+2.5} | tₖ₊₃ | t_{k+3.5} | tₖ₊₄ | t_{k+4.5} | t_{k+4.5} |
| Ideal video | t_{k+0.5} | tₖ₊₁ | t_{k+1.5} | tₖ₊₂ | t_{k+2.5} | tₖ₊₃ | t_{k+3.5} | tₖ₊₄ | t_{k+4.5} | tₖ₊₅ |
| (overlay) | | | | | | | | | | |

TABLE IV depicts another exemplary output sequence for the same input frame sequence as depicted in TABLE II and III. The output video content sequence exhibits less video judder. Again the film judder would be no worse that film judder under conventional frame rate conversion, as Film Content rows of TABLE II, TABLE III and TABLE IV are all identical. However, video judder under exemplary embodiments of the present invention would be greatly improved.

FIG. 6 depicts a plot of video judder for the frame sequence output depicted in TABLE IV, exemplary of the present invention. Again, the video judder for the output of the exemplary FRC is much smaller than the corresponding judder for the conventional FRC depicted in FIG. 4. In particular it is observed that video content output by the exemplary FRC all lie very close to a straight line 602. In fact the video contents for frames fₙ, fₙ₊₁, fₙ₊₂, fₙ₊₄, fₙ₊₅, fₙ₊₆, fₙ₊₇, fₙ₊₈ lie along line 602. Again, there are no sharp displacements in FIG. 6 that are comparable to those in FIG. 4.

As noted above, the use of embodiments of the present invention is particularly advantageous for input frames containing both film and video content originating with sources captured at different frame rates. The video content may come in the form of subtitle text, information tickers, PiP video, graphics animations and the like, that are typically superposed onto a cinema derived field sequence.

In an alternate embodiment, an exemplary frame rate converter need not have its own cadence detector, but instead may receive a cadence indicator signal corresponding to the input frames received.

Although exemplary embodiments have been discussed in relation to a frame rate conversion from 60 fps to 120 fps, a skilled reader would readily appreciate that other input frame rates, output frame rates and other ratios of output frame rate to input frame rate can be readily accommodated in other embodiments of the present invention. For example, the output frame rate of an exemplary FRC need not be double the input rate. Instead, the scaling frequency input may be used to indicate the desired ratio of incoming rate of input frames and the outgoing rate of output frames formed by the FRC.

Circuits such as FRC 106, exemplary of embodiments of the present may be found in digital television sets, and other displays, standalone video processors, graphics processing units (GPUs), projectors and the like. Exemplary circuits may be formed as application specific integrated circuits (ASIC) using well known VLSI techniques and tools.

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

What is claimed is:

1. A method of providing frame rate converted video comprising:
buffering sequential input video frames received at a first frame rate in a buffer, said input video frames containing blended content comprising: a first content from a first video sequence having a first cadence; and a second content from a second video sequence having a second cadence;
forming interpolated frames, by interpolating at least two of said input video frames in said buffer to form a corresponding interpolated frame for each of said input video frames; and
providing output frames at a second frame rate, by selectively outputting one of said interpolated frames and said frames in said buffer as an output frame, depending on said first cadence so as to reduce video judder in said second content in said output frames.

2. The method of claim 1, wherein said first and second video sequences are field sequences.

3. The method of claim 0, further comprising forming said input video frames from said first and second field sequences by de-interlacing.

4. The method of claim 0, wherein said first and second sequences are 60 Hz field sequences, and said first sequence is derived from a 24 frames per second (fps) film using 3:2 pull-down.

5. The method of claim 1, wherein said input video frames comprise Cₖ, Cₖ₊₁, Cₖ₊₂, Cₖ₊₃, Cₖ₊₄ . . . and said output frames comprise Cₖ, Fₖ, Cₖ₊₁, Fₖ₊₁, Fₖ₊₁, Cₖ₊₂, Fₖ₊₂, Cₖ₊₃, Fₖ₊₃, Fₖ₊₃, . . . wherein each Fᵢ denotes a frame formed by interpolating frames Cᵢ and Cᵢ₊₁ for i=k, k+1, k+2, . . . .

6. The method of claim 1, wherein said input video frames comprise Cₖ, Cₖ₊₁, Cₖ₊₂, Cₖ₊₃, Cₖ₊₄ . . . and said output frames comprise Fₖ, Cₖ₊₁, Fₖ₊₁, Fₖ₊₂, Fₖ₊₂, Cₖ₊₃, Fₖ₊₃, Cₖ₊₄, Fₖ₊₄, Fₖ₊₄, . . . wherein each Fᵢ denotes a frame formed by interpolating frames Cᵢ and Cᵢ₊₁ for i=k, k+1, k+2, . . . .

7. The method of claim 1, wherein said second frame rate is greater than said first frame rate.

8. The method of claim 1, wherein said first video sequence is derived by way of a 3:2 pull-down telecine conversion from a 24 fps cinema source.

9. A method of converting input video frames received at a first rate into output frames provided at a second rate, said input video frames containing a blend of a first and a second video content having a first and a second cadence respectively, said method comprising:
i) detecting said first cadence and said second cadence; and
ii) providing said output frames by selectively interpolating said input video frames based on said first and second cadence so as to reduce judder in said first and second content in said output frames.

10. The method of claim 9, wherein said first cadence is 3:2 pull down.

11. A frame rate converter circuit comprising:
an interpolator for forming interpolated video frames from at least two input video frames, said input video frames received sequentially at a first rate, said input video frames containing: a first and second content formed from two video sequences having a first and a second cadence respectively;
a cadence detector for detecting at least one of said first and second cadence to provide a cadence indicator;
a controller for providing a selection parameter based on said cadence indicator, determined so as to reduce judder in said first and second contents in said output frames; and
an output interface for providing output frames at a second rate by selectively outputting one of said input video frames and said interpolated video frames, in accordance with said selection parameter.

12. The circuit of claim 11, wherein said input video frames comprise Cₖ, Cₖ₊₁, Cₖ₊₂, Cₖ₊₃, Cₖ₊₄ . . . and said output frames comprise Cₖ, Fₖ, Cₖ₊₁, Fₖ₊₁, Fₖ₊₁, Cₖ₊₂, Fₖ₊₂, Cₖ₊₃, Fₖ₊₃, Fₖ₊₃, . . . wherein each Fᵢ denotes a frame formed by interpolating frames Cᵢ and Cᵢ₊₁ for i=k, k+1, k+2, . . . .

13. The circuit of claim 11, wherein said input video frames comprise Cₖ, Cₖ₊₁, Cₖ₊₂, Cₖ₊₃, Cₖ₊₄ . . . and said output frames comprise Fₖ, Cₖ₊₁, Fₖ₊₁, Fₖ₊₂, Fₖ₊₂, Cₖ₊₃, Fₖ₊₃, Cₖ₊₄, Fₖ₊₄, Fₖ₊₄, . . . wherein each Fᵢ denotes a frame formed by interpolating frames Cᵢ and Cᵢ₊₁ for i=k, k+1, k+2, . . . .

14. The circuit of claim 11, wherein said interpolator is a motion compensating interpolator.

15. The circuit of claim 11, further comprising a buffer for buffering said input video frames.

16. The circuit of claim 15, further comprising a second buffer for storing said interpolated frames formed by said interpolator.

17. The circuit of claim 15, wherein said buffer is a first-in first-out buffer and said second buffer is a first-in first-out buffer.

18. The circuit of claim 17, wherein said buffer stores at least four of said input video frames and said second buffer stores at least three of said interpolated video frames.

19. An integrated circuit comprising the circuit of claim 11.

20. A display comprising the integrated circuit of claim 19.
